(19) United States
(12) Patent Application Publication
(10) Pub. No.: US 2025/0169650 A1
(43) Pub. Date: May 29, 2025

(54) GRINDING APPARATUS AND METHOD, CORRESPONDING MACHINE AND METHOD FOR PREPARING BEVERAGES

(71) Applicant: DE’LONGHI APPLIANCES S.R.L. CON UNICO SOCIO, Treviso (IT)

(72) Inventors: Enrico ZARATIN, Treviso (IT); Simone ROSETTA, Treviso (IT); Giovanni ROSSETTO, Treviso (IT); Roberto SANSON, Treviso (IT); Igor PICCOLI, Treviso (IT); Marco FACCO, Treviso (IT)

(21) Appl. No.: 18/725,650

(22) PCT Filed: Dec. 28, 2022
(86) PCT No.: PCT/IT2022/050344

§ 371 Date: Jun. 28, 2024

(30) Foreign Application Priority Data
Dec. 30, 2021 (IT) 102021000033062

(51) Int. Cl. A47J 42/44

(52) U.S. Cl. CPC A47J 42/44

(57) ABSTRACT

Grinding apparatus including a hopper provided with feed means, the hopper being configured to contain and feed the beans, a grinding device configured to grind the beans, and weighing means for weighing the beans.

### FIELD OF THE INVENTION

The present invention concerns a grinding apparatus suitable to grind predefined doses of beans, in particular—but not only—coffee beans. The grinding apparatus can be the autonomous type, or integrated inside a machine for preparing beverages. The present invention also concerns a method for grinding beans, a machine and the corresponding method for preparing a beverage.

### BACKGROUND OF THE INVENTION

In the field of machines for preparing beverages, in particular those for producing coffee-based beverages are known, mainly for domestic use, in which the beverage is obtained by infusing an aromatic mixture of ground coffee.

Machines are known which, in addition to an infusion unit, comprise a grinding apparatus to produce said mixture starting from coffee beans contained in a suitable hopper, which can be fixed on the structure of the machine, or removable.

Removable type hoppers enable consumers to change the type of coffee beans to be used, since they have a container provided with a lower exit aperture which can be closed by means of one or more closing elements, through which the coffee beans can enter the grinding apparatus.

During use, the lower aperture normally remains open, so that the coffee beans fall into the grinding device by gravity, filling the available space. When the hopper is removed, both a certain quantity of coffee powder and also a quantity of coffee beans to be ground remain in the grinding device.

Consequently, when changing the hopper or replacing the type of beans to be used, in order to prevent contamination between different types of beans, or to prevent spillage of the product, it is necessary to empty the grinding device, either manually or by preparing a beverage with the remaining type of beans. Additionally, especially if the apparatus is not used for some time, the beans and the powder remaining in the grinding device can deteriorate and lose their aroma.

To try to overcome these problems, solutions are known in which the quantity of coffee beans entering the grinding apparatus is measured by volumetric dosing devices.

However, these volumetric dosing devices of a known type do not allow an adequate measurement of the quantity of beans, and the doses of beans supplied to the grinding apparatus do not exactly correspond to the quantity of product powder required to deliver the beverage selected by the user. In fact, beans of different origins can have very different shapes and sizes, so that even the quantity by weight in the same volume can vary greatly, depending on the origin.

Solutions are also known which provide dosing devices located between the hopper and the grinding apparatus, the function of which is to selectively transport a predefined dose of beans from the hopper to the grinding device.

Furthermore, these known solutions are able to supply only predefined and constant doses of beans and it is not possible to vary the quantity of beans for a single dose as desired.

Solutions are also known which provide to weigh the coffee powder obtained downstream of the grinding device.

These solutions do not solve the problem of residual beans in the dosing device or in the grinding device and the consequences indicated above.

Documents US-A-2019/0254464 and US-A-2018/0344088 describe grinding apparatuses of the autonomous type, also called “stand alone”, which are configured to supply predefined doses of ground coffee to a filter holder and comprise load cells provided between a support base, so that in practice they weigh the entire grinding apparatus, except the filter holder which is connected on a separate support structure. However, since these solutions entail weighing the entire grinding apparatus, that is, at least the container of the beans, the grinding device, the housing structure and the devices that convey the beans and coffee powder, they require large-scale load cells, and therefore do not guarantee the correct weighing of a few grams of coffee with respect to the total weight, which can also be around 3-6 kg.

Document US-A-2018/0153332 describes another known solution of an apparatus for supplying doses of ground coffee, which comprises a container which feeds beans by gravity to a grinding device, which discharges the coffee powder into a delivery conduit supported by load cells and provided in its lower part with a motorized closing door which releases the coffee powder into a filter holder. Since this solution weighs the powder only after it has been ground, it does not allow to adjust the dose actually supplied to the filter holder in a suitable way, but only possibly to recalibrate the quantities for subsequent doses.

US-A-2007/257142A1 describes an apparatus comprising a hopper connected to a first channel for feeding coffee beans into a first channel toward weighing means which are disposed upstream of a grinding device and into a second channel for supplying at exit coffee beans that have not been weighed, in which there is also a valve that can be driven to selectively open one of either the first or the second channel. In order to be able to release the weighed substance into the grinder, the weighing means provide a second motorized actuator, thus making this solution complex and expensive.

U.S. Pat. No. 4,789,106 describes an apparatus for weighing and grinding coffee beans which comprises at least two hoppers containing the beans, each of which is provided with a gate-type closing door; the apparatus can be driven by means of a solenoid to feed the beans by gravity to a collection container in order to weigh them by means of an arm system held by a magnet which, when the weight force overcomes the magnetic attraction force, opens a passage for the beans to a grinding device.

There is therefore a need to perfect a grinding apparatus and method, and a machine and method for preparing a beverage, which can overcome at least one of the disadvantages of the state of the art.

To do this it is necessary to solve the technical problem of providing a dosing device suitable to supply predefined and precise quantities to said grinding device, so that the correct quantity of beans required can be fed.

One purpose of the present invention is to provide a grinding apparatus and method which allow to measure the exact quantity of beans which is fed to the grinding device so as to supply the required quantity of powder on each occasion without leaving residual beans in the grinding device.

Another purpose of the present invention is to provide a grinding apparatus and method, and a machine and a method for preparing a beverage which allow to change the variety of beans, or in general of the dry food substance to be used, preventing contamination with the previous one.

Another purpose of the present invention is to provide a grinding apparatus and method which allow to vary the quantity of beans for a single dose according to requirements.

Another purpose of the present invention is to perfect a machine and a method for preparing a beverage which allow to keep the grinding device substantially empty between two successive beverage preparations.

Another purpose of the present invention is to provide a grinding apparatus and a machine for preparing a beverage which are versatile and simple to use for the user.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, a grinding apparatus according to the present invention comprises:
at least one hopper provided with feed means which are able to be selectively driven to feed beans toward an exit aperture,
a grinding device comprising a collection and grinding chamber configured to receive the beans from the hopper and grinding means configured to grind the beans into powder, and
weighing means which support the collection and grinding chamber and are configured to weigh the grinding device, its content and every component thereof.

In accordance with another aspect of the invention, the grinding apparatus comprises a control and command unit connected to the weighing means and configured to command the drive at least of the feed means and the grinding device in real time, as a function of the data detected by the weighing means.

Doing so achieves at least the advantage of creating a grinding apparatus that allows to measure and control the exact quantity of beans which is fed to the grinding device.

Furthermore, by weighing the grinding device directly it is possible to define the dose of beans to be used precisely and to supply, on each occasion, the required quantity of powder without leaving residual beans inside the grinding device, which could deteriorate or lose their aroma.

Thanks to the fact that weighing means are provided which weigh the grinding device and its contents, as opposed to systems with volumetric dosing devices, this solution allows to vary the quantity of beans for a single dose as a function of requirements, substantially continuously, without being bound to discrete preset doses.

In accordance with another aspect of the present invention, the weighing means comprise, or consist of, load cells and/or dynamometers which connect the grinding device to a support structure so that the grinding device is supported by the load cells and/or by the dynamometers.

In accordance with another aspect of the present invention, the weighing means weigh only the grinding device, its contents and its components.

By components of the grinding device, here and hereafter in the description we mean in particular the collection and grinding chamber, the grinders and the drive member associated with the grinders, that is, the unit which performs the function of grinding the beans and is therefore disposed floating with respect to the support structure of the apparatus thanks to the load cells and/or the dynamometers.

In accordance with another aspect of the present invention, the weighing means are connected on one side to a mobile plate and on the other side to a fixed portion of the support structure, by means of mechanical support means which are configured in such a way as to keep the grinding device floating with respect to the fixed support structure and to allow it to be weighed.

The mechanical support means can comprise at least one elastic element configured to dampen any vibrations, or other disturbances, at least during the weighing of the quantity of beans fed into the grinding device.

According to some embodiments, there are provided end-of-travel members between the grinding device, or a component integral therewith, and the fixed portion, which are configured to limit the travel of the grinding device so as to prevent excessive stresses on the load cells.

In accordance with another aspect of the present invention, the feed means comprise a feed member, disposed in the hopper, able to be associated with drive means and configured to convey the beans toward the exit aperture.

The feed member comprises a rotatable oblong body, extending along an axis of rotation, and at least one blade which extends in a direction radial to the axis of rotation, which is configured to selectively feed the beans toward the exit aperture and the grinding device.

According to a preferred embodiment, the axis of rotation is substantially inclined with respect to a vertical axis toward the lower aperture, and the feed member comprises a single blade.

According to one aspect of the invention, the at least one hopper comprises a lower plate having a bottom wall in which there is provided an aperture that defines the exit aperture, preferably disposed offset with respect to the axis of rotation, and a substantially cylindrical lateral wall, distanced from the perimeter edge of the bottom wall, which defines a chamber inside which the feed member is disposed, during use.

In the lateral wall, in correspondence with the exit aperture, there is preferably provided a portion protruding toward the outside of the lateral wall, which extends above the exit aperture in order to facilitate the passage of the beans.

In accordance with another aspect of the present invention, the feed means comprise a feed channel disposed in the at least one hopper, having a main development along a longitudinal axis, inside which there is disposed an auger able to be associated with drive means, the auger being disposed rotatable with respect to the longitudinal axis and configured to receive the beans coming from an entry aperture and to feed them toward the exit aperture.

In accordance with another aspect of the present invention, the drive means are disposed outside the hopper.

According to another aspect of the invention, the apparatus comprises two or more hoppers, each one suitable to contain beans, which are both connected by means of a conveyor to a single grinding device. A user can, on each occasion, select the hoppers in order to command, on each occasion, the feed means of the selected hopper in order to feed the beans present therein to the grinding device.

In accordance with another aspect of the present invention, a grinding method for preparing a desired dose of powder substance starting from a substance in the form of beans comprises:
receiving an indication of a desired value of a quantity of beans to grind;
driving feed means of a dosing device, which are disposed inside the at least one hopper, in order to selectively feed the quantity of beans toward a grinding device;
weighing, substantially continuously, an instantaneous value of the quantity of beans fed into the grinding device, and sending a signal relating to such instantaneous value to the control unit in order to compare the instantaneous value with the desired value;
when the instantaneous value corresponds to the desired value, stopping the feed means and activating the grinding device in order to completely grind the quantity of beans and obtain the desired dose of powder.
   By “instantaneous value” here and hereafter in the description we mean the value measured in the instant in which the weighing occurs. The weighing action is carried out in a substantially continuous manner by detecting, in succession, a plurality of samples of instantaneous values with a very high sampling frequency, for example 20-100 samples/second so as to know the weight of the hopper in real time.

In accordance with another aspect of the present invention, the method comprises a control step to verify that the entire quantity of beans fed to the grinding device has been completely ground before switching the grinding device off.

In accordance with another aspect of the present invention, the control step is carried out by weighing the quantity of beans remaining in the grinding device and/or by detecting the current intensity absorbed by the grinding device and/or by detecting the rotation speed of the grinding device during the grinding step, for example determined on the basis of the number of revolutions performed by the grinding device in a unit of time.

In accordance with another aspect of the present invention, the control step through weighing provides to stop the grinding device after a certain time interval correlated to the quantity of beans to grind, weigh the grinding device to determine the weight of any residual quantity of beans, calculate an additional grinding time sufficient to grind the residual quantity and once again activate the grinding device at least for the additional grinding time.

According to another aspect of the invention, the control step through weighing provides to continue to weigh the grinding device while it is in operation in order to grind the beans into powder, and to stop the grinding device when an instantaneous value detected by the weighing means corresponds to zero, or to a reference tare value correlated to the weight of the grinding device when it is empty.

In accordance with another aspect of the present invention, a machine for preparing coffee beverages comprises a grinding apparatus as disclosed above, a support structure, shaped in such a way as to internally have a compartment, the support structure being configured to cooperate with the grinding device, an infusion unit and at least one user interface provided with at least one display device by means of which a user can select a certain beverage, set one or several characteristics thereof, or select other options or operating modes.

In accordance with another aspect of the present invention, a method for preparing a beverage according to the present invention comprises at least: receiving a command for the preparation of coffee beverages in a machine for preparing coffee beverages, determining a desired value of quantity of beans necessary and sufficient to prepare the selected beverage; preparing a desired dose of powder having a quantity corresponding to the desired value, wherein a dosing device, disposed inside a hopper, is driven to selectively feed the quantity of beans toward a grinding device; the weighing means weigh the instantaneous value of the quantity of beans fed into the grinding device and send a signal relating to the instantaneous value to a control unit, which compares it with preset values relating to the selected beverage which are stored in a storage device; when the instantaneous value measured corresponds to the desired value relating to the selected beverage, the dosing device is stopped and the grinding device is activated in order to completely grind the quantity of beans and obtain a powder to be fed to an infusion unit; a step in which the powder is subjected to infusion and the beverage is delivered.

According to one aspect of the present invention, the method for preparing a beverage comprises a control step in which the control unit verifies that the quantity of powder fed to the infusion unit corresponds to the preset value relating to the selected beverage, before the powder is subjected to infusion and the beverage is delivered.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic and simplified representation of a grinding apparatus according to the present invention integrated in a machine for preparing a beverage;

FIG. 1a is a schematic and simplified representation of the grinding apparatus and of the machine of FIG. 1 in a condition in which the hopper is extracted;

FIG. 2 is a schematic exploded view of a hopper of the grinding apparatus in accordance with a first embodiment of the present invention;

FIG. 3 is a schematic section detail of a grinding apparatus, in accordance with the first embodiment, in a first operating condition;

FIG. 4 is a schematic section detail of the grinding apparatus of FIG. 3 in a second operating condition;

FIG. 5 is a schematic perspective view of the grinding apparatus in accordance with the first embodiment of FIGS. 2-4 integrated in the machine of FIG. 1;

FIG. 6 is a top view of FIG. 5;

FIG. 7 is a schematic perspective view of a grinding apparatus in accordance with a second embodiment in a first operating condition;

FIG. 8 is a partial section view of the grinding apparatus of FIG. 7 in a second operating condition;

FIG. 9 is a schematic view of a part of the grinding apparatus according to the invention;

FIG. 10 is a schematic view of a variant of a grinding apparatus in accordance with a third embodiment of the invention.

FIG. 11 is a block diagram relating to a control circuit of the grinding apparatus according to the present invention.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

With reference to the attached drawings, a grinding apparatus 10, 110, 210 according to the invention is described, configured to receive at entry a food substance in the form of beans or grains and grind it so as to obtain a dose of mixture in powder form.

The grinding apparatus 10, 110, 210 can be an autonomous apparatus of the “stand alone” type, or it can also be integrated in a machine 200.

The present invention also concerns a machine 200, provided with the apparatus 10, 110, 210 and usable to prepare a beverage through the infusion of the powdered mixture.

Please note that by the terms “beans” and/or “grains”, here and hereafter in the description we mean in particular coffee beans or parts thereof. However, other types of food substances, such as for example seeds, cereals, barley, salt or peppercorns, or suchlike, are not excluded.

The apparatus 10 is provided with a fixed support structure 18 configured to support its various components. In the case of an apparatus 10 of the autonomous type, the support structure 18 can be a portion of a bearing structure or of a cover of the apparatus 10.

According to possible variants, in the case of an apparatus 10 integrated in a machine 200, the support structure 18 could be connected to, or defined by, a support structure 201 of the machine 200, shaped in such a way as to have, internally, a compartment 202 in which the different components of the machine 200 are housed.

The apparatus 10 comprises at least one hopper 11, configured to contain and feed the beans, and a grinding device 12.

The apparatus 10 also comprises feed means 29, located at least partly inside the hopper 11, configured to selectively feed the beans to the grinding device 12, which define at least part of a dosing device 13.

The hopper 11 comprises a container 14 for containing the beans and is provided with an exit aperture 17 through which the beans can exit.

According to some embodiments, the dosing device 13 comprises the feed means 29 disposed inside the container 14, which are able to be selectively driven to feed the beans toward the exit aperture 17, and weighing means 70 associated with the grinding device 12.

The feed means 29 therefore form part of the hopper 11 itself, while the weighing means 70 are separate and independent therefrom.

However, the hopper 11 according to the invention could also be used in apparatuses 10 provided with weighing means 70 associated with different components, for example associated with the hopper 11, or with positions disposed upstream of the grinding device 12, or even weighing means suitable to weigh the ground coffee powder downstream of the grinding device 12.

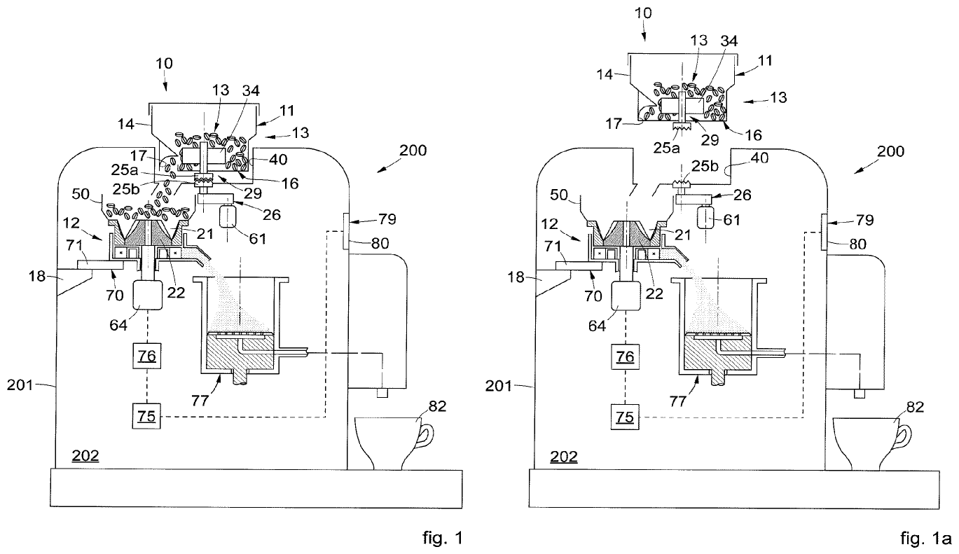

Some embodiments described here also concern a hopper 11 comprising a container 14 for the beans, a closing bottom 16 disposed rotatable with respect to the container 14 in order to selectively open and close the exit aperture 17 for the beans, and feed means 29 able to be selectively driven to feed the beans toward the exit aperture 17. The hopper 11 can be selectively inserted (FIG. 1) into, and extracted from, a housing compartment 40 (FIG. 1a) of the apparatus 10.

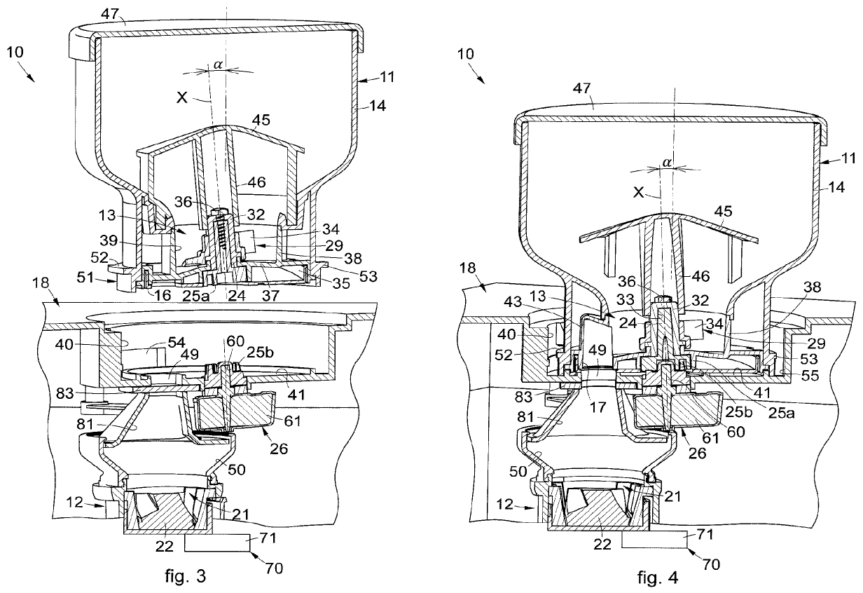

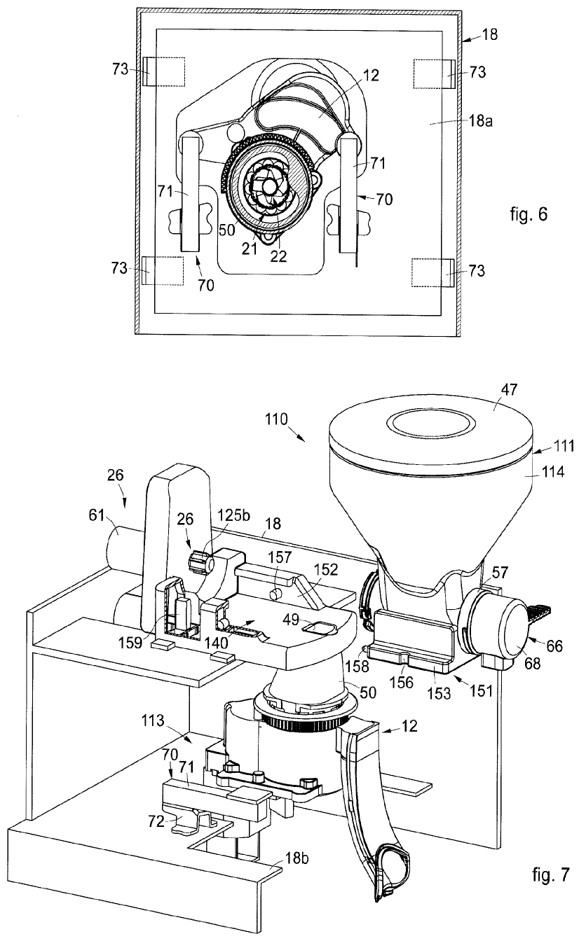

According to a first embodiment described with reference to FIGS. 1-6, the container 14 is provided with a lower aperture 15 and the hopper 11 comprises a closing bottom 16 which is disposed rotatable with respect to the container 14 in order to selectively open and close the exit aperture 17 of the beans.

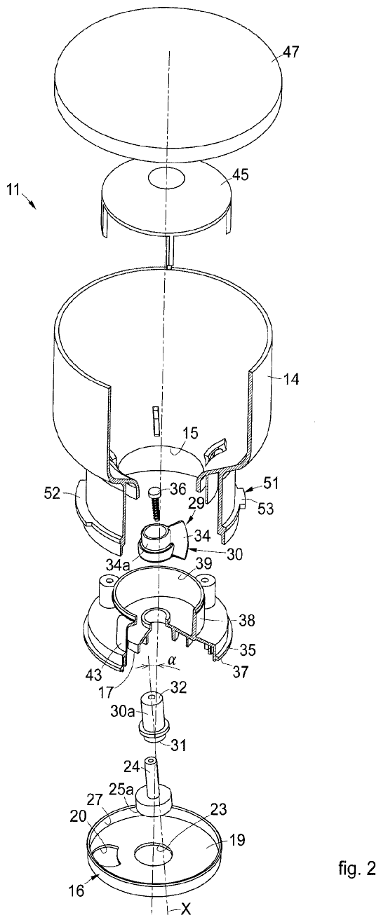

The bottom 16 comprises a bottom wall 19 (FIG. 2) in which a passage aperture 20 for the beans is made, which in an open condition is aligned with the exit aperture 17 of the beans, while in a closed condition is disposed offset with respect to the exit aperture 17, and the latter is closed by the bottom wall 19.

The bottom wall 19 can also be provided with a central hole 23 through which there is disposed a drive pin 24 to drive at least the feed means 29 of the dosing device 13, from the outside of the hopper 11, that is, of the container 14, as will be described below.

The pin 24 is disposed inside the hopper 11, rotatable on a first axis of rotation X inclined, with respect to a vertical axis, by an angle of inclination a, optimized for the purposes of the functionality of the feed means 29, for example comprised between 5° and 20°, and it is provided at the lower part with connection members 25a to be connected, during use, to mating connection members 25b of drive means 26.

For example, the drive means 26 can comprise, or consist of, one or more electric motors and are preferably associated with the support structure 18 outside the hopper 11. The drive means 26 connect to the feed means 29 when the hopper 11 is inserted in, and coupled to, the housing compartment 40.

The drive means 26 can comprise a drive shaft 60 connected to a drive member 61 and suitable to engage, with its own connection members 25b, with the connection members 25a of the drive pin 24, in order to make it rotate. The drive shaft 60 and the drive member 61 can be connected to each other, for example, directly or by means of one or more intermediate idle gears and members.

The bottom 16 can also comprise a lateral wall 27 and the passage aperture 20 can be delimited by the lateral wall 27 or it can also be made through it.

The bottom 16 can be provided with clamping members, not shown in the drawings, suitable to engage with respective second clamping members, for example present in the compartment 40 of the apparatus 10, which is associated with, or defined by, the support structure 18, in order to clamp the bottom 16 and allow a rotation of the container 14 with respect thereto in order to open the passage aperture 20, as will be better described below.

The bottom wall 19 can be made, or comprise at least one portion, of rubber or other deformable material suitable to guarantee a sealed closure of the hopper 11 when the bottom 16 is in the closed condition.

With reference to FIGS. from 2 to 6, the feed means 29 comprise, or consist of, a feed member 30 disposed rotatable around an axis of rotation X inclined, with respect to the vertical axis, by an angle of inclination a comprised between 3° and 20°.

In particular, the feed member 30 is disposed rotatable with respect to the axis of rotation X of the pin 24 and it can be connected thereto.

According to some embodiments, the feed member 30 has an oblong body 30a, which comprises a first end 31, lower during use, and a second end 32, upper during use.

The first end 31 comprises a cavity 33 configured to allow an association of the feed member 30 with the pin 24. For example, the shape and sizes of the pin 24 can be such as to allow an insertion of the oblong body 30a inside the cavity 33, in such a way as to define a reciprocal coupling and drag it in rotation. The two elements, that is, the pin 24 and the oblong body 30a, can be connected to each other by means of a screw 36.

According to other embodiments, the pin 24 and the feed member 30, or the oblong body 30a, are made in a single piece.

The feed member 30 also comprises a blade 34, or propeller, made of rigid plastic material for example, which extends in a radial direction with respect to a longitudinal axis of the oblong body 30a, configured to selectively move the beans toward the exit aperture 17, as will be described in detail below.

The blade 34 can extend directly from the oblong body 30a or be associated with it by means of its own central hub 34a.

According to some embodiments, there is a single blade 34, although it is not excluded that in possible variants there are two or more blades 34.

The hopper 11 also comprises a plate 35, able to be associated with the lower aperture 15 and with the bottom 16, which comprises a bottom wall 37, provided with the exit aperture 17, and a substantially cylindrical lateral wall 38 which extends from one side of the bottom wall 37, distanced from the perimeter edge, which defines a chamber 39 inside which the feed member 30 is disposed, during use. The plate 35 can also define part of the dosing device 13.

According to possible variants, the blade 34 can comprise at least one flexible portion made of rubber, silicone, or other elastic or flexible material. Preferably, the flexible portion is provided on the end portion that, during use, faces the internal surfaces of the chamber 39.

The exit aperture 17 of the plate 35 is preferably disposed misaligned with respect to the axis of rotation X and to a central hole 42, and it extends at least partly outside the lateral wall 38, on which there can be provided a protruding portion 43 in correspondence with the exit aperture 17 to facilitate the passage of the beans. The beans are therefore actively thrust by the blade 34 by centrifugal acceleration toward the exit aperture 17, from which they then fall by gravity.

According to some embodiments, the grinding device 12 comprises a grinding chamber 21, into which the beans are conveyed, and a pair of grinders 22 for grinding the beans, which can be selectively distanced in order to vary the granulometry of the powder substance.

According to some embodiments, the weighing means 70 comprise one or more load cells 71 associated, for example attached, with the support structure 18. According to possible embodiments, the weighing means 70 could comprise, or consist of, one or more dynamometers.

According to one aspect of the present invention, the load cells 71 or the dynamometers connect the grinding device 12, and in particular the chamber 21, to a support structure 18 of the apparatus 10.

In other words, the weighing means 70, that is, the load cells 71 or the dynamometers, support the chamber 21 and are configured to weigh the grinding device 12, its contents and each of its components.

In particular, the grinding device 12 can be connected to the support structure 18 exclusively by means of the weighing means 70, that is, it is located substantially floating with respect to the other components of the apparatus 10 and in particular it is separate and disconnected from the hopper 11, 111 and/or from the compartment 40 (see FIG. 1a).

The components of the grinding device 12 which are weighed by the weighing means 70 comprise the grinding chamber 21, the grinders 22, a drive member 64 associated with the grinders, and, where present, a collection chamber 51 for the beans, that is, the components which form the unit which performs the function of grinding the beans and is in fact disposed floating with respect to the support structure 18 of the apparatus 10.

The apparatus 10 can comprise one or more mechanical support means 73 configured to connect the weighing means 70 to the support structure 18.

According to some embodiments, the weighing means 70, that is, the load cells 71, are connected on one side to a mobile plate 18a which can in turn be connected to the chamber 21 of the grinding device 12, and on the other side to a fixed portion 18b of the support structure 18.

For example, the mechanical support means 73 could comprise the mobile plate 18a to which, by means of brackets or semi-rigid support elements 72, the weighing means 70 associated with the grinding device 12 are attached, or the mechanical support means 73 could consist of one or more semi-rigid support elements 72, which allow to separate the load cells 71 with respect to a fixed portion 18b of the support structure 18.

According to possible variants, the mechanical support means 73 can comprise, or consist of, one or more elastic elements 74, having a first end 74a associated with the fixed portion 18b of the support structure 18 and a second end 74b associated with the mobile plate 18a, which is in turn connected to the weighing means 70 by means of the semi-rigid elements 72.

Thanks to the presence of the elastic elements 74, if an excessive force is exerted on the grinding device 12, the mechanical support means 73 flex and the grinding device 12 moves to an end-of-travel position without excessively stressing the load cells 71. This will be described in greater detail below.

The elastic elements 74 could comprise, for example, one or more springs, and be configured to dampen vibrations, or any other disturbances, during the weighing of the beans present inside the grinding device 12, so that the weighing is more accurate, as will be explained in detail in the following description.

The apparatus 10 could comprise 3 or more elastic elements 74, disposed around the grinding device 12 in order to equally distribute any loads and possible stresses.

Furthermore, the mechanical support means 73 have the function of making the grinding device 12 “floating” with respect to the support structure 18, that is, with respect to the fixed portion 18b. This advantageously allows to greatly reduce the vibrations and noise produced by the apparatus 10 during its use.

According to other simplified embodiments, the semi-rigid elements 72 can be connected directly to the fixed portion 18b and, if suitably sized, can themselves act as an elastic element.

Between the fixed portion 18b, or components integral therewith, and the grinding device 12, or components integral therewith, there are provided end-of-travel members 41, 44 which are configured to cooperate reciprocally and limit the displacement of the grinding device 12 with respect to the fixed portion 18b.

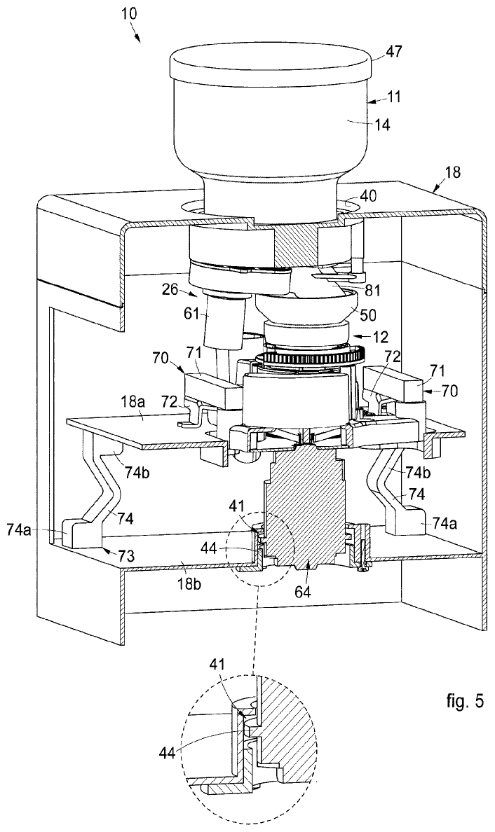

For example, FIG. 5 shows the grinding device 12 connected to the load cells 71 which, in turn, are connected to the mobile plate 18a by means of the semi-rigid support elements 72, in the example case the brackets. The mobile plate 18a is in turn connected to the fixed portion 18b by means of the elastic elements 74.

According to other variants, the grinding device 12 could be directly connected, by means of the load cells 71, to the fixed portion 18b of the support structure, as shown by way of example in FIG. 1a.

In the example case of FIG. 5, the end-of-travel members 41, 44 are, respectively, one integral with the fixed structure 18b and one with the drive member 64 which is associated with the grinding device 12 and configured to rotate the grinders 22.

According to some embodiments, a seating 41 can be provided on the fixed portion 18b and the drive member 64 can comprise a protuberance 44 which protrudes radially and is mobile with a certain clearance in several directions inside the seating 41.

In this case, the seating 41 and the protuberance 44 act as end-of-travel members.

When forces greater than the contrast forces provided by the mechanical support means 73 are exerted on the grinding device 12, this is displaced until the protuberance 44 comes into contact with a wall of the seating 41, thus limiting the travel of the grinding device 12, with the aim of preventing accidental overloads acting on the weighing devices 70.

The apparatus 10 also comprises a control unit 75 configured to regulate its operation.

The control unit 75 is, in particular, connected to the weighing means 70 and is configured to receive at entry the measurement detected by them, and command the selective and coordinated operation of the various components, for example, of the dosing device 13 and of the grinding device 12.

In particular, the control unit 75 is configured to command the feed means 29 as a function of the data received from the weighing means 70, in order to feed into the grinding chamber 21, on each occasion, only the quantity of beans required to obtain a predefined dose of powder substance.

The control unit 75 can in particular be configured to command the feed means 29 in real time, on the basis of the data received from the weighing means 70.

For example, a set of values relating to the quantity of powder substance required to prepare one or more beverages could be stored in a storage unit 76 associated with the control unit 75, and the latter could command the selective operation of the dosing device 13 until the quantity of beans present in the grinding device 12 corresponds to one of such values, for example:

| Type of beverage | Grams required | |
|---|---|---|
| Extra light coffee | 4 | g |
| Light coffee | 6 | g |
| Normal coffee | 8 | g |
| Strong coffee | 10 | g |
| Extra strong coffee | 12 | g |

According to other variants, the apparatus 10 comprises a user interface 79 by means of which to directly enter a command relating to a quantity by weight, or a dose of powder substance required.

According to the embodiment of FIGS. 1-6, the container 14 comprises an upper aperture 44 configured to allow the insertion of the beans, which can be closed substantially hermetically by means of a lid 47.

With the container 14 of the hopper 11 there can be associated a protective element 45, or protective wall, also called “finger guard”, which comprises, in correspondence with one of its surfaces, lower during use, a hollow seating 46, or support, with a shape and sizes suitable to house the second end 32 of the feed member 30, so as to support the latter. The seating 46 can comprise, for example, rolling elements, such as one or more bearings, to facilitate the rotation of the feed member 30 inside it.

According to some embodiments, shown in FIGS. 2-5, the hopper 11 and the support structure 201 are provided with respective coupling and clamping members 51 configured to cooperate with each other in such a way as to allow a reciprocal coupling in the vertical direction, while preventing a reciprocal rotation.

The clamping members 51 can comprise at least one tab 52 protruding radially from the lateral wall of the container 11 and at least one mating cavity or groove 54 suitable to create a bayonet-type coupling.

Preferably, two tabs 52, 53 are provided, each suitable to be inserted into a cavity or groove 54, 55 thereof, disposed angularly offset from each other, the sizes of which advantageously differ from each other in order to allow a univocal positioning of the hopper 11.

A microswitch or other device suitable to detect the presence of the tabs 52, 53 can be disposed inside at least one cavity 54, 55. Once the tabs 52, 53 have been inserted in the respective cavities 54, 55, the container 14 can be rotated so as to clamp it with respect to the support structure 18, for example by an angle of approximately 40°-50°.

The rotation of the container 14 involves the alignment between the exit aperture 17 and the passage aperture 20 on the bottom 16, allowing the beans to transit through them.

According to some embodiments, the compartment 40 can comprise a bottom wall 41 in which there is provided an inlet 49 for the beans which faces the grinding device 12.

Below the inlet 49 there can be disposed a chamber 50 for collecting the beans, which is connected to the grinding chamber 21 and has the function both of conveying the beans toward the grinding device 12 and also of allowing an accumulation of the beans in the grinding chamber 21. The volume of the collection chamber 50 is designed, in particular, in such a way as to contain a quantity of beans by volume corresponding to the maximum quantity of beans by weight that can be selected, possibly taking into account a certain margin of error, for example 10%, for safety reasons.

The collection chamber 50 is advantageously integral with the grinding device 12 and is separate from the inlet 49. A conveyor 81 can possibly be present between the inlet 49 and the collection chamber 50. The collection chamber 50 is in any case also separate from the conveyor 81.

The support structure 18 can comprise a cover door 83 suitable to selectively close the inlet 49 when no hopper 11 is inserted.

The door 83 can comprise engagement members, not shown in the drawings, suitable to engage with corresponding second engagement members present on the container 14 in such a way that a rotation of the latter with respect to the support structure 18 entails a simultaneous movement of the door 51 in order to open or close the inlet 49.

The selective opening and closing of the inlet 49 can therefore occur through the manual rotation of the container 11 in one or the other direction.

According to some embodiments, with the door 83 there can be associated elastic interference means configured to keep the door 83 in the closed or open position, preventing an accidental movement thereof. The interference means can comprise, for example, elastic elements, for example a spring, associated with a pin which interacts with respective recesses present in the door and causes an interference to the sliding in correspondence with the open and closed positions.

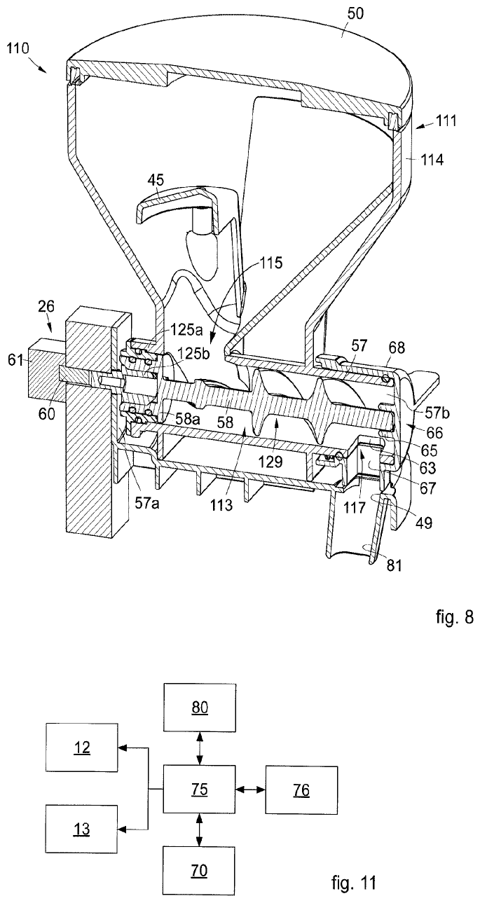

FIGS. 7 and 8 show a second embodiment of an apparatus 110, in which the elements substantially the same as those of the first embodiment of FIGS. 2-6 are indicated with the same reference numbers, while elements that have similar functions, but different conformations, are indicated with the same reference number increased by 100.

The grinding device 12 and the weighing means 70 associated therewith are substantially the same as those of the embodiment shown in FIGS. 2-6 and will not be described further.

In particular, also in this embodiment, the weighing means 70 comprise, or consist of, load cells 71 and/or dynamometers which connect the grinding device 12 to a support structure 18 so that the grinding device 12 is supported, preferably exclusively, by the load cells 71 and/or by the dynamometers.

According to the embodiments of FIGS. 7 and 8, the feed means 129 comprise a feed channel 57 having a main development along a longitudinal axis Y, which in the example shown in the drawings is horizontal, which is inside the container 114 of the hopper 111.

The hopper 111 shown in FIGS. 7 and 8 could also be used with apparatuses 110 of different types, provided with weighing means 70 associated with other components, such as the same hopper 111 for example, or with positions disposed upstream of the grinding device 12, or even with weighing means suitable to weigh the ground coffee powder downstream of the grinding device 12.

The feed means 129 also comprise an auger 58, disposed inside the feed channel 57, rotatable with respect to the longitudinal axis Y, configured to selectively feed the beans coming from the hopper 111 toward an exit aperture 117 and then toward the grinding device 12.

The drive means 26 can be disposed in correspondence with a first longitudinal end 57a of the feed channel 57 and they can comprise a drive member 61 and a drive shaft 60, which comprises connection members 125b configured to engage with mating connection members 125a disposed in a first longitudinal end 58a of the auger 58.

The drive member 61 is advantageously disposed outside the hopper 111, so as to allow an easy removal thereof.

According to possible embodiments, the auger 58 and the drive shaft 60 can be connected to each other directly or by means of one or more idle gears, not shown in the drawings.

The feed channel 57 comprises an aperture, or a hole 63 defining the exit aperture 117, facing the inlet section 49 of the conveyor 81, if present, or of the collection chamber 50, at the opposite end of which the grinding device 12 is installed.

In correspondence with a second longitudinal end 57b, opposite the first end 57a of the feed channel 57, there is disposed an adjustment member 66.

The feed channel 57 comprises a mobile closing wall 67 in correspondence with the hole 63, configured to be moved selectively by using the adjustment member 66 and prevent the beans from escaping through the closing wall 67 through an overlap with the exit aperture 63.

The possibility of selectively closing the hole 63 and therefore the exit aperture 117 of the beans, advantageously allows to easily replace the hopper 111 without causing unwanted falls of the beans.

The adjustment member 66 comprises a knob 68 installed in correspondence with the second longitudinal end 57b of the feed channel 57, rotatable with respect to the longitudinal axis Y, configured to command the selective overlap of the closing wall 67 and of the hole 63, and therefore the closure of the exit aperture 117.

As can also be seen in FIG. 7, the hopper 111 is removably associated with a housing compartment 140 connected to, and integral with, the support structure 18.

In this solution, the hopper 111 and the compartment 140 can be provided with respective coupling members 151 configured to cooperate with each other in such a way as to allow a reciprocal coupling in a vertical or horizontal direction.

The coupling members 151 can comprise, for example, one or more grooves, or other guide elements 152, created on opposite lateral walls of the compartment 140, and one or more elements 153 protruding from a lateral wall of the hopper 111 which are suitable to cooperate with the guide elements 152, or vice versa.

According to other embodiments, not shown, the coupling members 151 can be oriented in a different direction, for example vertically, or even be of another type.

The coupling members 151 can also comprise or cooperate with clamping members 155 configured to guarantee a reciprocal clamping between the hopper 111 and the compartment 140. In the example case, there can be provided a recess 156 created on the hopper 111 and one or more elastic stop pegs 157 disposed in the compartment 140, or vice versa.

The hopper 111 can also comprise an actuator 158 configured to activate a position sensor 159 provided in the compartment 140 when the hopper 111 is clamped therein.

In the example shown in FIG. 7, the weighing means 70 are connected to a fixed portion 18b only by means of the semi-rigid elements 72.

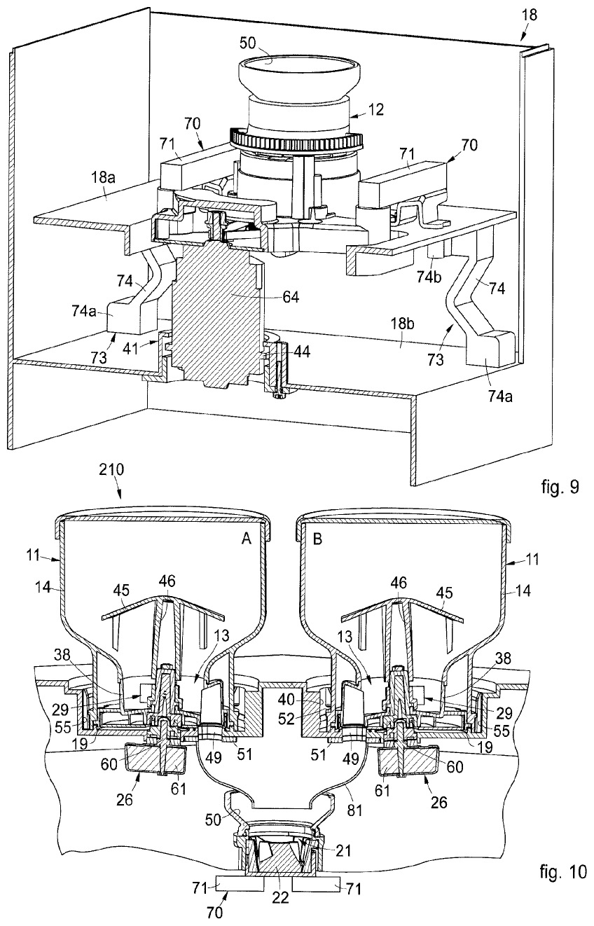

In the example shown in FIG. 9, which could be provided in combination with one 11 or the other hopper 111, the mechanical support means 73 comprise both semi-rigid elements 72 and also elastic elements 74 which connect the grinding device 12 and the weighing means 70 to the fixed portion 18b.

FIG. 10 shows another embodiment of an apparatus 210 comprising two hoppers 11, also indicated with the letters “A” and “B”, which can be removably connected in respective housing compartments 40 of the support structure 18. However, the number of hoppers 11 could also be higher, for example between three and five, and they could also be of the fixed type.

In the example case, both hoppers 11A, 11B supply the beans to a same grinding device 12 and are connected to the same collection chamber 50 by means of a conveyor 81.

The connections of the grinding device 12 to the load cells 71 and to the support structure 18 by means of the support means 73 are substantially the same as those described for the other embodiments.

The feed means 29 can be connected to respective drive means 26 which can be selected independently of each other.

In the case of two or more hoppers 11, selection means can be provided, for example integrated in a user interface 79 or made as mechanical type members, by means of which a user can select one or the other hopper 11, and the control unit 75, on the basis of the selection made, can command the respective feed means 29.

According to other embodiments, if the hoppers 11 contain different beans, it can also be provided that a user can select a certain percentage of beans for each of the hoppers 11, for example 50-50%, 20-80%, 30-70% or other, and the control unit 75 can command the respective feed means 29 of one and the other hopper 11 simultaneously, or preferably in sequence, to obtain a dose of both types of beans with the required percentages.

With reference to FIG. 1, a machine 200 according to the present invention can comprise, in addition to the components described above, an infusion unit 77 configured to prepare a certain beverage, a hydraulic circuit, not shown in the drawings, for feeding water to the infusion unit 77, and a delivery apparatus hydraulically connected to the infusion unit 77, which allows to deliver the certain beverage into a container 82, for example a cup, a mug, or suchlike.

The machine 200 can comprise a user interface 79 provided with a display device 80, for example a touchscreen, by means of which a user can select a certain beverage, set one or more characteristics thereof, or select other options or operating modes of the machine 200.

The operation of the grinding apparatus 10, 110, 210 described heretofore, which correspond to the grinding method for preparing a dose of powder substance according to the invention, comprises the following steps.

A first step in which a quantity of beans is supplied inside the hopper/s 11, 111 such as to at least partly fill the container/s 14, 114.

A subsequent step in which a user supplies and/or selects a command for the preparation of a dose of powder substance, in the case of an autonomous apparatus 10, or for the preparation of a beverage, in the case of a machine 200.

In the latter case, the user can also set one or more characteristics of the machine 200, or can select other options or operating modes thereof. This step can be carried out, for example, using the display device 80. Please note that the quantity of beans required to prepare the beverage selected by the user can be stored in the storage unit 76, or it can possibly be modified by the user.

The method also comprises a subsequent step in which the feed means 29, 129 which form part of the dosing device 13, 113 are driven to selectively feed the beans toward the grinding device 12.

With reference to the embodiment shown in FIGS. from 2 to 6, the beans fall by gravity through the aperture 15 and thus fill the chamber 39 inside which the feed member 30 is disposed.

The feed member 30 is made to rotate selectively around the axis of rotation X, so that its blade 34 pushes the beans that are in the chamber 39 toward the exit aperture 17, the passage aperture 20 and then the inlet 49 to the collection chamber 50.

Instead, with reference to the embodiment shown in FIGS. 7 and 8, the beans fall by gravity through the aperture 15 and fill at least a first portion, toward the left in FIG. 8, of the feed channel 57.

The auger 58 is activated and made to rotate around the longitudinal axis Y, so that it transports the beans in the longitudinal direction Y (horizontally to the right in FIG. 8) toward the exit aperture 117 and consequently toward the inlet 49 of the collection chamber 50.

During this step, while the feed means 29, 129 are in operation, the weighing means 70 weigh, substantially continuously, the instantaneous value of the quantity of beans present in the grinding device 12, and send a signal to the control unit 75 which compares this measured value with the preset value relating to the selected beverage.

When the instantaneous measured value corresponds to the preset value, the feed means 29, 129 of the dosing device 13, 113 are stopped by the control unit 75, the feed of the beans to the grinding device 12 is interrupted and the grinding device 12 is activated in order to completely grind the beans present inside it and thus obtain the desired dose of powder.

The feed of the beans during this step could comprise a first initial sub-step in which the feed means 29, 129 are activated and made to rotate at a first speed, for example close to the maximum speed, or a predefined nominal speed, and a second sub-step in which the feed means 29, 129 are made to slow down and rotate with a second lower speed, so as to allow a more gradual and precise dosing of the beans to the grinding device 12.

For example, the passage from the first speed to the second speed can be performed when the weighing means 70 detect that the weight of the beans inside the grinding device 12 has reached a certain reference value, for example corresponding to a percentage comprised between 70% and 90% of the total weight of the quantity required, preferably about 75-85%.

The method for preparing a dose of powder substance comprises a control step to verify whether there is a residual quantity of beans in the grinding device 12, or whether the entire quantity of beans fed has been completely ground, before switching off the grinding device 12.

According to some embodiments, the control step provides to stop the grinding device 12, and in particular the grinders 22, after a certain time interval correlated to the quantity of beans to be ground, weigh the grinding device 12 in order to determine, if present, the weight of any residual quantity of beans by subtracting the tare weight of the grinding device 21 from the measured value, calculate an additional grinding time sufficient to grind the residual quantity and activate the grinding device 12 again, at least for the additional grinding time.

According to possible variants, the control step through weighing provides to continue to weigh the grinding device 12, substantially continuously, while it is in operation to grind the beans into powder, and to stop the grinding device 12 when an instantaneous value detected by the weighing means 70 corresponds to zero or to a tare reference value correlated to the weight of the grinding device 12 when it is empty.

Alternatively, or in addition, the control unit 75 could detect the current intensity absorbed by the grinding device 12 and compare it with a predetermined, or expected, current value relating to the specific beverage and to the strength thereof which are selected by the user, the current value being stored in the storage unit 76, for example. For example, this detection of the current intensity absorbed can be performed by one or more current sensors, not shown in the attached drawings.

Alternatively, or in addition, the control unit 75 could compare the difference in the speed of the rotation of the drive member 64 or of the grinders 22, for example detected by means of special sensors, not shown, with respect to the steady state normal operating values.

For example, the control unit 75 can detect the rotation speed of the grinders 22 or of the drive member 64, and compare it with a predetermined value, for example stored in the storage unit 76, or with a rotation speed detected in a previous instant.

In the case of an autonomous apparatus 10, 110, 210, the powder can be fed to a filter holder, or other container; while in the case of an automatic and/or manual type machine 200, it can be fed directly to the infusion unit 77.

The powder can be fed to the infusion unit 77, for example through a fall by gravity.

According to some embodiments, it can be provided that the control unit 75 verifies that the quantity of powder fed to the infusion unit 77 corresponds to the preset value relating to the beverage selected by the user before the powder is subjected to infusion and the beverage is delivered.

This verification can be carried out, for example, by weighing the residual quantity of beans present inside the grinding device 12 when the powder is fed to the infusion unit 77.

According to some embodiments, this verification can provide to detect the volume of the quantity of coffee powder present in the infusion unit 77 after it has been subjected to compression, and comparing it with an expected volume value for a certain dose of powder stored in the storage unit 76.

According to some embodiments, the method according to the invention can provide to compact the coffee powder fed to the infusion unit 77 with a defined pressure, measuring the height of the coffee mound obtained by means of detection sensors, not shown, and comparing it with a pre-stored expected value in order to verify whether the quantity of coffee powder fed to the infusion unit 77 corresponds to the quantity required for the selected beverage.

If the quantity of coffee powder in the infusion unit 77 does not correspond to the quantity required, the control unit 75 can carry out a feedback adjustment in order to adjust the rotation of the drive means 29, 129 and the value of the reference weight to be considered for the preparation of a subsequent beverage.

According to possible variants, if the quantity of powder fed to the infusion unit 77 is lower than the predetermined one, the control unit 75 can send a command signal to activate the grinding device 12, so that it completely grinds the beans present inside it, and/or the dosing device 13, 113, so that the feed means 29, 129 can feed other beans toward the grinding device 12.

It is clear that modifications and/or additions of parts may be made to the grinding apparatus 10, 110, 210, to the machine 200 and to the methods for preparing a dose of powder substance and a beverage as described heretofore, without departing from the field and scope of the present invention, as defined by the claims.

It is also clear that, although the present invention has been described with reference to some specific examples, a person of skill in the art shall certainly be able to achieve many other equivalent forms of grinding apparatuses and methods, machines and methods for preparing a beverage, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Grinding apparatus (10, 110, 210) comprising:
at least one hopper (11, 111) provided internally with feed means (29, 129) which are able to be selectively driven to feed said beans toward an exit aperture (17, 117),
a grinding device (12) comprising a chamber (21, 50) configured to receive the beans from said hopper (11, 111) and grinding means (22) for grinding said beans and obtaining said powder substance, wherein said apparatus (10, 110, 210) also comprises:
weighing means (70) which support said chamber (21, 50) and are configured to weigh said grinding device (12), its content and every component thereof, and
a control and command unit (75) configured to command the drive at least of said feed means (29, 129) and said grinding device (12) in real time, as a function of the data detected by said weighing means (70).

2. Apparatus (10, 110, 210) as in claim 1, wherein in that said weighing means (70) comprise, or consist of, load cells (71) and/or dynamometers which connect said grinding device (12) to a support structure (18) so that said grinding device (12) is supported by said load cells (71) and/or by said dynamometers.

3. Apparatus (10, 110, 210) as in claim 2, wherein in that said grinding device (12) is supported exclusively by said load cells (71).

4. Apparatus (10, 110, 210) as in claim 1, wherein said weighing means (70) weigh only said grinding device (12), its contents and its components.

5. Apparatus (10, 110, 210) as in claim 1, wherein said weighing means (70) are connected to said support structure (18) of said grinding apparatus (10, 110, 210) by means of mechanical support means (73) comprising at least one semi-rigid element (72) or an elastic element (74).

6. Apparatus (10, 110, 210) as in claim 5, wherein said weighing means (70) and/or said at least one elastic element (74) is/are fixed to at least one mobile plate (18a) to which said grinding device (12) is connected, wherein between said grinding device (12) and said fixed portion (18b), or between respective components integral therewith, there are provided end-of-travel members (41, 44) configured to reciprocally cooperate and limit the displacement of said grinding device (12) with respect to said fixed portion (18b), with the aim of limiting accidental overloads acting on said weighing means (70).

7. Apparatus (10, 210) as in claim 1, wherein said feed means (29) comprise a feed member (30) able to be connected to drive means (26) and configured to convey said beans present in said hopper (11) toward said exit aperture (17), wherein said feed member (30) comprises a rotatable oblong body (30a) extending along a first axis of rotation (X) and a blade (34) which extends in a radial direction and is configured to selectively feed said beans toward said exit aperture (17).

8. Apparatus (10, 210) as in claim 7, wherein said first axis of rotation (X) is inclined toward said exit aperture (17), with respect to a vertical axis, by an angle of inclination (a) comprised between 5° and 20° and said feed member (30) comprises a single blade (34).

9. Apparatus (10, 210) as in claim 7, wherein said hopper (11) comprises a plate (35), having a bottom wall (37) provided with said exit aperture (17) in the proximity of a perimeter edge thereof, offset with respect to said first axis of rotation (X), and a substantially cylindrical lateral wall (38), distanced from said perimeter edge, which defines a chamber (39) inside which there is disposed, during use, said feed member (30).

10. Apparatus (110) as in claim 1, wherein said feed means (129) comprise a feed channel (57), having a main development along a longitudinal axis (Y), inside which there is disposed an auger (58) able to be connected to drive means (26), said auger (58) being disposed rotatable with respect to said longitudinal axis (Y), configured to receive said beans coming from an entry aperture (115) and to feed them through said exit aperture (117) toward said grinding device (12).

11. Apparatus (10, 110, 210) as in claim 5, wherein said drive means (26) are associated with said support structure (18) and are disposed outside said hopper (11, 111).

12. Apparatus (10, 110, 210) as in claim 1, wherein it comprises two or more hoppers (11, 11A, 11B, 111) removably connected to said support structure (18), wherein said two or more hoppers (11, 11A, 11B, 111) are connected, and feed beans, to the same grinding device (12).

13. Machine (200) to prepare coffee beverages, wherein it comprises an apparatus (10, 110, 210) as in claim 1, at least partly housed in a compartment (202) of a support structure (201) integral with the support structure (18) of said apparatus (10, 110, 210), an infusion unit (77) and at least one user interface (79) provided with at least one display device (80) by means of which a user can select a certain beverage, set one or more characteristics thereof, or select other options or operating modes.

14. Grinding method for preparing a dose of powder substance starting from a substance in the form of beans contained in a hopper (11, 111), able to:
receive an indication of a desired value of a quantity of said beans to grind;
drive feed means (29, 129) of said hopper (11, 111), to selectively feed said quantity of beans through an exit aperture (17, 117) toward a grinding device (12) comprising a chamber (21, 50) and grinding means (22);
weigh, substantially continuously, an instantaneous value of said grinding device (12), of its content and every component thereof, in order to measure said quantity of beans fed into said grinding device (12);
compare said instantaneous value measured with said desired value and, if they coincide, stop said feed means (29, 129) in real time and activate said grinding device (12) to grind said quantity of beans into powder.

15. Grinding method as in claim 14, wherein it provides to switch said grinding device (12) off only after said quantity of beans fed has been completely ground.

16. Grinding method as in claim 14, wherein it provides to stop said grinding device (12) after a certain time interval correlated to said quantity of beans to grind, weigh said grinding device (12) to determine, if present, the weight of said residual quantity of beans, calculate an additional grinding time sufficient to grind said residual quantity and once again activate said grinding device (12) at least for said additional grinding time.

17. Grinding method as in claim 14, wherein it provides to continue to weigh said grinding device (12) while it is in operation in order to grind said quantity of beans into powder, and to stop said grinding device (12) when an instantaneous value detected by said weighing means (70) corresponds to zero or to a reference tare value correlated to the weight of the grinding device (12) when it is empty.

18. Grinding method as in claim 14, wherein it provides to detect at least one of either the current intensity absorbed by said grinding device (12) and/or the rotation speed of said grinding device (12) during the grinding step as above and compare them with respective threshold values in order to determine whether the entire quantity of beans fed has been ground.

19. Grinding method as in claim 14, wherein it provides to initially drive said feed means (29, 129) to make them rotate at a first speed and, when said instantaneous value measured corresponds to a reference value correlated to a percentage of said quantity of beans to grind, slow them down and make them rotate at a second speed lower than said first speed.

20. Method for preparing a beverage, wherein it comprises receiving a command for the preparation of a selected beverage in a machine (200) for preparing beverages, determining a quantity of beans necessary and sufficient to prepare said selected beverage and execute:
a step of preparing a dose of powder substance in which feed means (29, 129), disposed inside a hopper (11, 111) associated with said machine (200), are driven to feed said quantity of beans toward a grinding device (12);
a step, simultaneous with the previous one, in which weighing means (70) weigh the instantaneous value of said grinding device (12), of its content and every component thereof, in order to measure said quantity of said beans fed into said grinding device (12), and send a signal relating to said instantaneous value to a control unit (75) which compares it with preset values relating to said selected beverage which are stored in a storage device (76);
a step in which, when said instantaneous value measured corresponds to the preset value relating to said quantity of beans necessary and sufficient for said selected beverage, said feed means (29, 129) are stopped and said grinding device (12) is activated to completely grind said quantity of beans and obtain said powder substance to be fed to an infusion unit (77);
a step in which said powder is subjected to infusion and said beverage is delivered.

21. Method for preparing a beverage as in claim 20, wherein it also comprises a control step in which said control unit (75) verifies that the quantity of said powder fed to said infusion unit (77) corresponds to said preset value before subjecting it to infusion and delivering said beverage.
